(19) United States
(12) Patent Application Publication
(10) Pub. No.: US 2010/0126951 A1
(43) Pub. Date: May 27, 2010

(54) Wire cable tray

(76) Inventors: Richard Gregg Winn, Belleville, IL (US); Tarek M. Shaltout, Tyler, TX (US)

Correspondence Address: DOUGLAS E. WARREN;ATTORNEY AT LAW, P.O. BOX 6727, CHESTERFIELD, MO, 63006, US

(21) Appl. No.: 12/592,566

(22) Filed: Nov. 27, 2009

Related U.S. Application Data
(63) Continuation-in-part of application No. 12/319,836, filed on Jan. 13, 2009.
(60) Provisional application No. 61/118,270, filed on Nov. 26, 2008.

(51) Int. Cl. B65D 1/34; F16L 3/22

(52) U.S. Cl. 211/133.5; 248/68.1

(57) ABSTRACT

A cable tray constructed of longitudinal and transverse members having a shape in which the vertical dimension of the shape is greater than the horizontal dimension of the shape wherein the longitudinal or transverse members are positioned such that the vertical dimension of the shape is substantially perpendicular to the load being placed on the cable tray.

### CROSS REFERENCE TO RELATED APPLICATIONS

This application claims the benefit of all applicable priority, including the application filing date, from Provisional Application Ser. No. 61/118,270 filed on Nov. 26, 2008, and from Nonprovisional application Ser. No. 12/319,836 filed on Jan. 13, 2009, and those applications are incorporated by reference herein in its entirety for all purposes.

### STATEMENT REGARDING FEDERALLY SPONSORED RESEARCH

Not Applicable.

### BACKGROUND OF THE INVENTION

Electrical system conductors are always part of the construction of virtually any building whether the building is residential, business, or even a storage building. In most applications, local construction codes and building techniques dictate the use of metallic conduit mounted to various surfaces of the building. The necessary electrical system conductors are then drawn through the metallic conduit to terminate at the various control points designed within the electrical system.

With the increase in electrical and signaling technology, there has also been an increase in the variety of cables used to interconnect electrical and electronic equipment. While the electrical industry still makes extensive use of copper and sometimes aluminum electrical conductors disposed within cables, the use of optical cables has also become widespread and there is every indication that the use of optical cables may surpass the current percentage of use of copper or aluminum conductor cables.

With the widespread use of a virtually endless variety of electronic equipment and devices, there has also been a constant and steady increase in the use of specialized electrical system conductors in raceways and mechanical areas that do not use normal metallic conduit. Instead, cable trays are first installed within the raceways and mechanical areas. Thereafter, the electrical system conductors and cables are placed into the cable trays where the electrical system conductors remain until they must be serviced or remodeled.

One standard type of cable tray is made from an assembly of wire rods. These rods are welded together at various angles to result in what is usually a channel-shaped trellis that can be used as a cable tray. These channel-shaped cable trays are installed within the raceways and mechanical areas such that the two opposing sides of the channel are generally vertical while the web connecting the two opposing sides is mounted to face upward against gravity. The electrical system conductors are placed within the channel-shaped cable tray by simply locating the length of the wires parallel to the longitudinal axis of the channel-shaped cable tray and allowing the electrical system conductors to rest directly upon the metal used to fabricate the channel-shaped tray.

While this type of cable tray offers a simple and generally strong design for mounting loose electrical system conductors, the direct contact of the certain types of electrical system conductors onto the wire rods of the channel-shaped tray can introduce high areas of mechanical stress on the underside of the electrical system conductors that can, over time and use, cause fatigue fractures to occur in the electrical system conductors. Such cracks not only cause severe operational problems with the electrical devices interconnected using the electrical system conductors, such cracks also present a serious fire hazard.

However, not all electrical conductors are as susceptible to such breaking. In these situations, chaffing of the conductors is not a major issue. Instead, there are more problems associated with the combined weight of the accumulated lengths of conductor as those conductors rest on the cable trays. When weight is a problem, excessive accumulations of wire weight within a cable tray can result in the bending or deformation of the cable tray. In the most severe situations, the cable tray structure can sometimes fail resulting in the collapse of the cable tray within the under floor system. Such deformations and collapses result in costly repairs and maintenance, and in some case, even complete disruption of the signals or power being transferred by the conductors.

Various embodiments of the present invention described herein include features and characteristics that tend to reduce the increase the strength of the wire cable tray thereby reducing the probability that a wire cable tray can fail from the excessive weight of carrying a large numbers of electrical conductors in the tray.

### SUMMARY OF THE INVENTION

This invention relates to an apparatus for installing electrical system conductors, and more specifically to the installation of electrical system conductors by placement of those electrical system conductors within a uniquely designed cable tray. More specifically and in accordance with the various embodiments of the present invention, a cable tray is disclosed that is made from an assembly of interconnected metallic rods. Various embodiments of the present invention utilize different shaped rods to provide combinations of concentrated strength and better rigidity resulting in a stronger cable tray better equipped to carry larger numbers of electrical system conductors disposed within the cable tray.

### DESCRIPTION OF THE DRAWINGS

In the accompanying drawings which form part of the specification:

FIG. 1 is a perspective view of one embodiment of the present invention showing one cable tray made from an assembly of wire rods.

FIG. 2 is a vertical section view of one embodiment of the present invention.

FIG. 3 is a top view of one embodiment of the present invention.

FIG. 4 is a left elevation view of one embodiment of the present invention.

FIG. 5 is a bottom view of one embodiment of the present invention.

FIG. 6 is a vertical cross section of one embodiment of the present invention showing one preferred shape of a U-shaped transverse member.

FIGS. 6A, 6B, and 6C are vertical cross sections similar to FIG. 6 but showing various shapes for that may be use in alternative embodiments of the present invention.

Corresponding reference numerals indicate corresponding steps or parts throughout the several figures of the drawings.

While one embodiment of the present invention is illustrated in the above referenced drawings and in the following description, it is understood that the embodiment shown is merely one example of a single preferred embodiment offered for the purpose of illustration only and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF A PREFERRED EMBODIMENT OF THE INVENTION

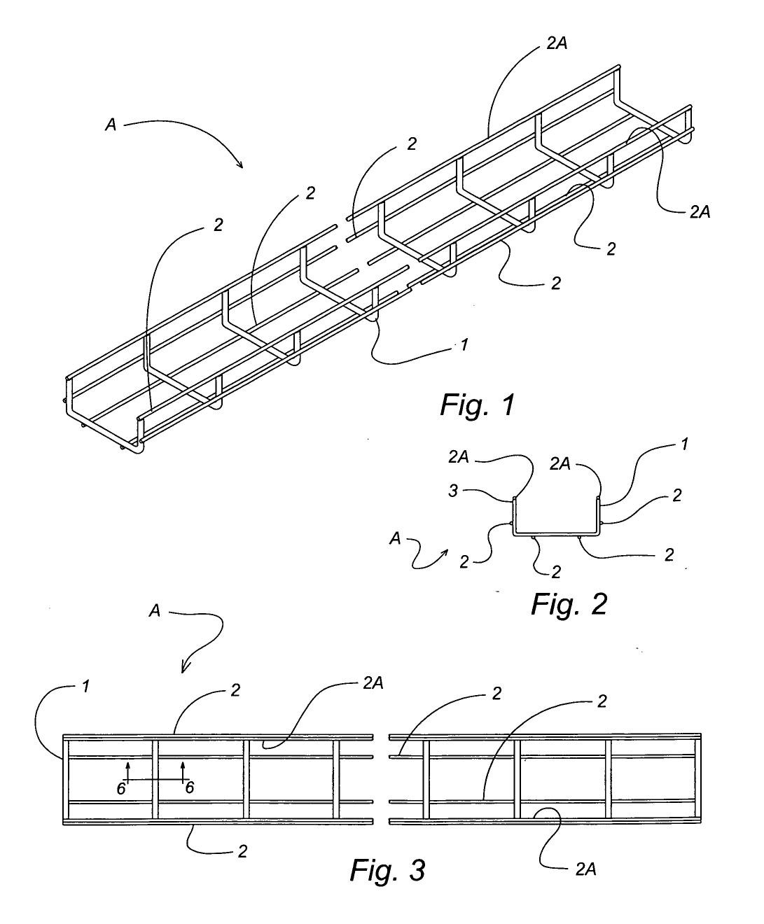

A set of preferred embodiments of the cable tray A of the present invention are illustrated in FIG. 1 through FIG. 6C. An example of the physical configuration of a preferred embodiment of the present invention is shown in FIG. 1 where the cable tray A comprises a plurality of U-shaped transverse members 1, a plurality of longitudinal members 2A. As is readily apparent, the plurality of U-shaped transverse members 1 are disposed substantially perpendicular to the plurality of longitudinal members 2 at a general spacing of about 3.9 inches on center. The longitudinal members 2 of the present embodiment are generally spaced about 2.0 inches on center.

Upon the positioning of the plurality of U-shaped transverse members 1 and the plurality of longitudinal members 2 it will be understood by those skilled in the art that at substantially each point where a single U-shaped transverse member 1 intersects with a single longitudinal member 2, the U-shaped transverse member and the longitudinal member are welded together in a preferred embodiment.

This is typical throughout the entire construction of the present embodiment of the invention with the exception of the longitudinal members 2. The other longitudinal members 2 are positioned such that the outer radius of the longitudinal member is welded against the outer radius of the adjacent U-shaped transverse member 1. In contrast, each of the two longitudinal members 2A is generally located at an end 3 (FIG. 2) of the plurality of U-shaped transverse members 2. The longitudinal members 2A are then welded in that position on the end 3 of the plurality of U-shaped members 1.

Although FIG. 1 through FIG. 6C disclose an embodiment of the present invention where the U-shaped transverse members 1 are positioned on the top of the longitudinal members 2, it is understood that other embodiments of the present invention can have the U-shaped transverse members 1 positioned under the longitudinal members 2. In yet other embodiments of the present invention, either the U-shaped transverse members 1, the longitudinal members 2, or both, can have the shapes wherein the vertical dimension of the shape is greater than the horizontal dimension of the shape. Thus, it is understood that the embodiments of the present invention are not intended to be restricted by whether the U-shaped transverse member 1 is positioned on the top of the longitudinal members 2, whether the longitudinal members 2 are positioned on top of the U-shaped transverse members 1, or which of either the U-shaped transverse members 1 or the longitudinal members 2 have shapes as noted herein. Instead, it is intended that each of those embodiments shall be within the scope of the disclosure and claims of the present application.

It will be appreciated by those skilled in the art that when the present embodiment of the cable tray A is fully constructed, the cable tray A (FIG. 1) is in the general shape of a channel having plurality of openings disposed between the framework of the assembled plurality of U-shaped transverse members 1 and the plurality of longitudinal members 2. It will also be appreciated that when fully assembled, the outside dimension of the cable tray A of the present embodiment has a width of about 3.5 inches and a height of about 1.5 inches. In alternative embodiments of the present invention, the width and height can be readily adjusted to fit the dimension into which the cable tray A will be installed. In most instances the width and height of the assembled cable tray A will comparable to the width and height dimensions of standard wood construction framing material.

It will also be understood that while preferred embodiments of the present invention as described herein show the cable tray A as being generally channel-shaped and that the transverse members 1 are U-shaped, the intended scope of this invention is not to be limited to only those embodiments that have channel shapes or U-shaped components. For example, other embodiments of the present invention include cable trays A that have a bottom and two sides where the two sides may be not be perpendicular to the bottom.

Other embodiments of the present invention include cable trays A where the two sides may be flared away from the longitudinal center of the bottom or flared toward the longitudinal center of the bottom, thereby making the interior angle formed by the sides and the bottom of each such embodiment either obtuse or acute respectively. This is to say, the angular placement of the sides of the present cable tray A in relation to the bottom of the cable tray may be adjusted as needed for specific applications and still remain within the intended scope of the present invention.

In a preferred embodiment, the overall length of the cable tray A is about 10 feet, however, the length of the cable tray A can be any other length while still remaining within the intended scope of the present invention.

Those skilled in the art will appreciate that the plurality of U-shaped transverse members 1 and the plurality of longitudinal members 2 may be of any type of material strong enough to support the weight to which the cable tray A is expected to support. In a preferred embodiment, the plurality of U-shaped members 1 and the longitudinal members 2 are made from a galvanized wire in accordance with ASTM A641. The zinc plating of the present embodiment is electrodeposited zinc having a Type III Finish and Service Condition One in accordance with ASTM B633. Alternatively, the finish of the material may also be a polyester powder coating having a general thickness of about 1.2 mils to about 3.0 mils. In yet other alternative embodiments of the present invention, the plurality of U-shaped transverse members 1 and the plurality of longitudinal members 2 and 2A are made from either carbon steel Brite Basic Wire in accordance with A510, Grade 1008, or alternatively, 304 & 306 Stainless Steel. To ensure that the assembled cable tray A shown in some preferred embodiments has a generally consistent shape and balance, the angular formations within the assembled cable tray should not vary by more than about ±3 degrees; the overall camber should not exceed 0.5 inches over each ten foot length of cable tray; and, the twist should not exceed 0.5 inches over each ten foot length of the cable tray.

Although the general characteristics of the cable tray A are substantially described and disclosed above, variations in the shape and orientation of the longitudinal members 2 and the plurality of U-shaped transverse members 1 provide a variety of preferable strength characteristics. More specifically, when electrical system conductors are installed in a prior art style cable tray having round or square U-shaped transverse members, the geometry of those member shapes provide much of the strength the cable tray A offers to resist the vertical loads placed on the cable tray by the combined weight of all the electrical conductors residing within the cable tray. Certain shapes, when oriented in certain ways, can provide enhanced resistance to loads. Various embodiments of the present invention incorporate new wire shapes for the members that are oriented to best provide the most load bearing capacity to the vertical loads the cable tray A may experience.

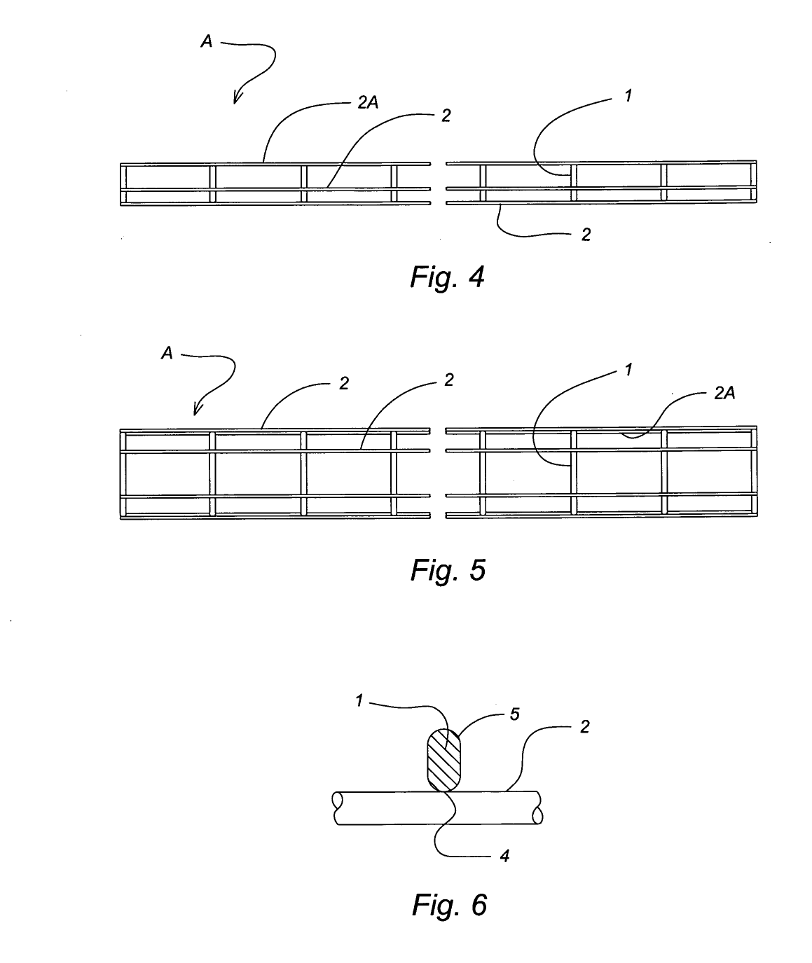

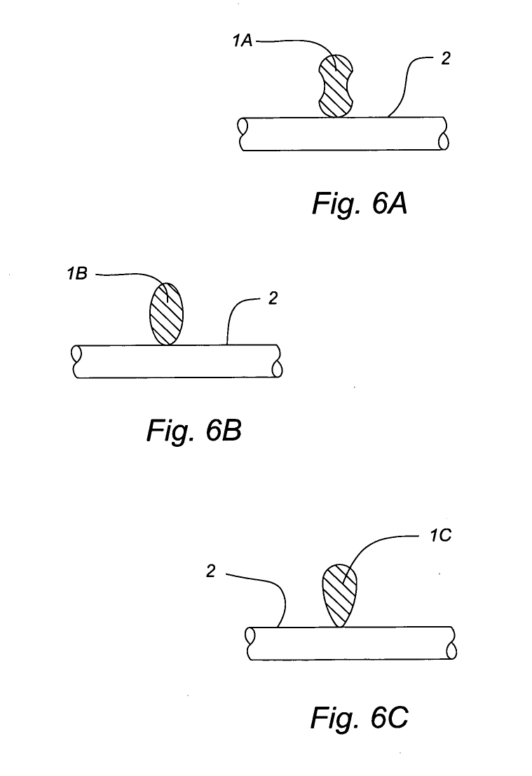

For example, the embodiment of the cable tray A as shown in FIG. 1, FIG. 2, FIG. 3, FIG. 4, FIG. 5, and FIG. 6 show the plurality of U-shaped transverse members 1 to be generally obround in shape (FIG. 6), having a height of about 6.5 mm and a width of about 3.5 mm. When the obround shape is used as a U-shaped transverse member 1, the rounded portion 4 of each of the plurality of U-shaped transverse members 1 rests upon the outer radius of each of the longitudinal members 2. This orientation of the obround U-shaped transverse member 1 positions the opposite rounded portion 5 of the obround shape upward to face the bottom of the electrical system conductors when the electrical system conductors are placed within the cable tray A. As can be seen, by orienting the obround shape of the U-shaped transverse member 1 such that the rounded portions are positioned at the top and bottom of the member, the shape of the member provides the greatest amount of resistance to the vertical loads in the cable tray A. This is to say, the obround rod oriented in this manner acts similar to an I-beam. It is understood that rotating the member 90 degrees in either direction will provide less resistance to the vertical loads similar to the lower load bearing capacity of an I-beam that is placed on its side. Thus, the result of the obround shape of the member and the orientation of the member results in the wire tray A having a significant increase in its load bearing capacity.

In this same manner, the longitudinal members 2 or the plurality of U-shaped transverse members 1 can be made using rods that provide yet other shapes that tend to increase the ability of the cable tray A to carry greater weights that result from the combined weight of the electrical system conductors residing within the cable tray. For example, the longitudinal members 2 or the plurality of U-shaped transverse members 1 may be shaped as shown in FIG. 6A, 6B, or 6C. In yet other embodiments of the present invention, the longitudinal members 2 or the plurality of U-shaped transverse members 1 may be in the shape of an I-beam. In fact, it is appreciated that the either the U-shaped transverse member 1 or the longitudinal members 2 may be of yet other shapes while still remaining with the intended scope of this invention and act to increase the load capacity of the cable tray, with the primary limiting factor for the chosen shape, and the dimension of that shape, being the shape's ability to provide the structural integrity to carry the weight of the number of electrical system conductors to be disposed within the cable tray A. This is to say, some preferred shapes do not have equally dimensioned vertical and horizontal cross sections. Instead, those preferred shapes have one cross section dimension along the vertical Y-axis that is greater than the dimension along the horizontal X-axis of the shape, and then the wire rod having that shape is oriented such that the axis of the greater sized cross is perpendicular to the vertical load being placed upon the cable tray A by the weight of the electrical conductors within the tray.

It will be appreciated that the orientation of the shape of the U-shaped transverse members 1 and the longitudinal members 2 as described above is used when the loads to be placed on the cable tray A are great and the application requires the wire tray to be strong. However, it will also be appreciated that in other embodiments of the cable tray A, not shown herein, the orientation of the U-shaped transverse members 1 and the longitudinal members 2 can be such that the wires are rotated about 90 degrees to prevent high stress concentration points between the electrical conductors in the wire tray and the U-shaped and longitudinal wires. Therefore, it is understood that the orientation of the wire shapes can be such as to increase the strength and loading capacity of the cable tray A as shown in the present application, or can be oriented to instead prevent chafing and damage to the electrical conductors as described in nonprovisional application Ser. No. 12/319,836. This is to say, the orientation of the wires can be dictated by the specific needs of the wire tray application and the present application claims the orientation of the wire shapes as needed to increase the strength of the cable tray A.

While the above description describes various embodiments of the present invention, it will be clear that the present invention may be otherwise easily adapted to fit any configuration where a cable tray is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

What is claimed is:

1. A cable tray comprising:
a plurality of U-shaped transverse members connected to a plurality of longitudinal members to result in the general shape of a channel capable of supporting a plurality of electrical system conductors within an inside of the channel, wherein at least one of either the plurality of U-shaped transverse members or the plurality of longitudinal members has a shape in which the vertical dimension of the shape is greater than the horizontal dimension of the shape, and wherein at least one of either the plurality of U-shaped transverse members or the plurality of longitudinal members is oriented such that the vertical dimension of the shape is positioned substantially perpendicular to a load being supported by the channel.

2. The cable tray of claim 1 wherein the cable tray is assembled such that the plurality of U-shaped transverse members is disposed within the inside of the channel.

3. The cable tray of claim 3 wherein the cable tray is assembled such that the plurality of longitudinal members is disposed on the outside of the channel.

4. The cable tray of claim 3 wherein each at least one of the plurality of longitudinal members is connected to each end of at least one of the plurality of U-shaped transverse members.

5. The cable tray of claim 4 wherein each of the plurality of longitudinal members is substantially obround in shape.

6. The cable tray of claim 5 wherein each of the plurality of U-shaped transverse members is substantially elliptical in shape.

7. The cable tray of claim 5 wherein each of the plurality of U-shaped transverse members is substantially a symmetrical concave polygon in shape.

8. The cable tray of claim 5 wherein each of the plurality of U-shaped transverse members is substantially in shape of an extreme elliptical.

9. A cable tray comprising:
a plurality of U-shaped transverse members connected to a plurality of longitudinal members to result in the general shape of a channel capable of supporting a plurality of electrical system conductors within an inside of the channel, wherein the cable tray is assembled such that the plurality of U-shaped transverse members is disposed within the inside of the channel, wherein the cable tray is assembled such that the plurality of longitudinal members is disposed on the outside of the channel, and wherein at least one of either the plurality of U-shaped transverse members or the plurality of longitudinal members has a shape in which the vertical dimension of the shape is greater than the horizontal dimension of the shape, and wherein at least one of either the plurality of U-shaped transverse members or the plurality of longitudinal members is oriented such that the vertical dimension of the shape is positioned substantially perpendicular to a load being supporting by the channel.

10. A cable tray comprising:
a trellis including a plurality of longitudinal wires and a plurality of U-shaped transverse wires fixed to one another, wherein the plurality of longitudinal wires run longitudinally along substantially the entire length of the tray, said plurality of transverse U-shaped wires being positioned transversely to the plurality of longitudinal wires and spaced substantially parallel to one another, said trellis defining a trough having a bottom and opposed sides, said plurality of longitudinal wires including edge longitudinal wires defining free edges of the opposed sides and bottom longitudinal wires forming the bottom of the trough, at least one of said bottom longitudinal wires having a cross section shape that is non-circular, the non-circular shape having a long axis and a short axis.

11. The cable tray according to claim 10 wherein the cross-sectional area of at least one longitudinal wire is different from at least one other longitudinal wire.

12. The cable tray according to claim 10 wherein the cross-sectional area of all the longitudinal wires is substantially the same.

13. The cable tray according to claim 10 wherein the cross-sectional shape of at least one longitudinal wire is different from at least one other longitudinal wire.

14. The cable tray according to claim 10 wherein the long axis of said bottom longitudinal wire is substantially perpendicular to the bottom of the trellis.

15. The cable tray according to claim 14 wherein the long axis of said bottom longitudinal wire is substantially parallel to the bottom of the trellis.

16. The cable tray according to claim 15 wherein said at least one bottom longitudinal wires is of obround, oval, rectangular, I-beam, or tear-drop cross-section.

17. A cable tray comprising:
a trellis including a plurality of longitudinal wires and a plurality of U-shaped transverse wires fixed to one another, the plurality of longitudinal wires running longitudinally along substantially the entire length of the tray, said plurality of transverse U-shaped wires being positioned transversely to the plurality of longitudinal wires and spaced substantially parallel from one another, said trellis defining a trough having a bottom and opposed sides, at least one of said plurality of U-shaped transverse wires having a cross-sectional shape that is non-circular, the non-circular shape having a long axis and a short axis.

18. The cable tray according to claim 17 wherein the long axis of said U-shaped transverse wire is substantially parallel to the bottom of the trellis.

19. The cable tray according to claim 17 wherein the long axis of said U-shaped transverse wire is substantially perpendicular to the bottom of the trellis.

20. The cable tray according to claim 17 wherein said at least one U-shaped transverse wire is of obround, oval, rectangular, I-beam, or tear-drop cross-section.

21. The cable tray according to claim 17 wherein the cross-sectional area of all the U-shaped transverse wires is substantially the same.

22. The cable tray according to claim 17 wherein the cross-sectional area of at least one U-shaped transverse wire is different from at least one other U-shaped transverse wire.

23. The cable tray according to claim 17 wherein at the cross-sectional shape of at least one U-shaped transverse wire is different from at least one other U-shaped transverse wire.

24. The cable tray according to claim 17 wherein said at least one U-shaped transverse wire is of oval cross-section.

25. The cable tray according to claim 17 wherein the cross-sectional area of all the U-shaped transverse wires is substantially the same.
